(19) United States
(12) Patent Application Publication
(10) Pub. No.: US 2009/0213926 A1
(43) Pub. Date: Aug. 27, 2009

(54) Method for Up-Sampling/Down-Sampling Data of a Video Block

(75) Inventors: IL-Hong Shin, Daegu-si (KR); Hyun Wook Park, Daejun-si (KR)

Correspondence Address: HARNESS, DICKEY & PIERCE, P.L.C., P.O. BOX 8910, RESTON, VA, 20195, US

(73) Assignee: LG ELECTRONICS INC., Seoul (KR)

(21) Appl. No.: 11/918,215

(22) PCT Filed: Feb. 24, 2006
(86) PCT No.: PCT/KR2006/000651

§ 371 Date: Jan. 21, 2009

Related U.S. Application Data
(60) Provisional application No. 60/655,434, filed on Feb. 24, 2005.
(60) Provisional application No. 60/663,753, filed on Mar. 22, 2005.
(60) Provisional application No. 60/663,735, filed on Mar. 22, 2005.
(60) Provisional application No. 60/663,754, filed on Mar. 22, 2005.

(30) Foreign Application Priority Data
Jun. 10, 2005 (KR) 10-2005-0049859

(51) Int. Cl. H04N 7/30

(52) U.S. Cl. 375/240.2; 375/E07.226

(57) ABSTRACT

The present invention relates to a method for up-sampling/down-sampling data of a video block in a scalable video data encoding/decoding. The up-sampling method according to the present invention obtains a 2N×2N enlarged block by computing a converting matrix to data of a given N×N video block. The converting block has matrix elements leading data of the video block to resultant data that could be obtained by a converting process that applies DCT to the data, pads some zeros to coefficients, and applies IDCT to the coefficients including the padded zeros. The down-sampling method according to the present invention obtains an N×N reduced block by computing a converting block to a given 2N×2N video block. The converting block for reducing has matrix elements leading data of the 2N×2N video block to resultant data that could be obtained by a converting process that applies DCT to the data, removes some coefficients from transformed coefficients, and applies IDCT to the remaining coefficients.

### TECHNICAL FIELD

The present invention relates to a method for up-sampling/down-sampling data of a video block in a scalable video data encoding/decoding.

### BACKGROUND ART

Scalable video coding refers to coding techniques which encode video data with the highest possible video quality such that lower-quality video may be obtained by decoding a partial sequence of the resultant coded video data, i.e., the sequence of video frames intermittently selected from the coded video data. The motion compensated temporal filter (MCTF) scheme is one of scalable video coding techniques.

Decoding of a partial sequence of video data encoded by the MCTF scheme may provide low-quality video but the video quality is deteriorated sharply with low bit rates. To solve this problem, separate auxiliary picture sequences for low bit rates, (e.g., picture sequences having smaller picture sizes and lower frame rates) may be provided in a hierarchical manner. For example, one video source may be coded into a 4CIF picture sequence, a CIF picture sequence, and a QCIF picture sequence separately and transmitted to a decoding apparatus. When a video source is coded into multiple hierarchical layers, data redundancy exists in the layers because the multiple layers are obtained from the same video source.

To increase the coding rate of a particular layer with the MCTF scheme, the video frame of the layer is coded as an image data predicted from a temporally corresponding video frame of a lower layer, i.e., residual data. For example, if a macro block of a current layer is to be encoded in the intra mode, the corresponding block of the lower layer, i.e., the macro block of the lower layer which has temporal and spatial correspondence, is enlarged and the difference (or error) between the macro block of the current layer and the enlarged block is encoded into the macro block of the current layer.

Because the enlarged block is not transmitted to the decoder, the decoder should decode a macro block encoded in the aforementioned manner by enlarging the corresponding macro block of the lower layer and utilizing the data. In addition to encoding of a macro block in the intra mode, the prediction of the residual data between layers also requires up-sampling of the lower-layer macro blocks.

As a result, if a plurality of layers having different picture sizes or resolutions is provided as an encoded stream, the enlargement (up-sampling) of macro blocks is required both in encoding and decoding processes.

When encoding a video source into a plurality of layers having different frame sizes, the encoder may construct a video block of a layer having a small frame size by down-sampling the data of a spatially corresponding block of an upper layer without actually encoding the video block. In this case, the encoder requires a method for down-sampling (or reducing) video blocks.

### DISCLOSURE OF THE INVENTION

It is an object of the present invention to provide a method for up-sampling/down-sampling data of a video block using the discrete cosine transform (DCT).

It is another object of the present invention to provide. a method for up-sampling/down-sampling data of a video block using type-1 and type-2 discrete cosine transforms (DCTs) commonly used in video signal processing.

The up-sampling method according to the present invention obtains a 2N×2N enlarged block by applying a transform matrix to the data of a given N×N video block. The transform matrix has elements for leading to resultant data that could be obtained by applying the DCT to the data of the given N×N video block, padding zeros to the coefficients obtained by the DCT, and applying the inverse discrete cosine transform (IDCT) to the zero-padded coefficients.

The down-sampling method according to the present invention obtains an N×N reduced block by applying a transform matrix to the data of a given 2N×2N video block. The transform matrix has elements for leading to resultant data that could be obtained by applying the DCT to the data of the given 2N×2N video block, removing some of the coefficients obtained by the DCT, and applying the inverse discrete cosine transform (IDCT) to the remaining coefficients.

In one embodiment of the present invention, the type-1 discrete cosine transform is used for the DCT.

In one embodiment, the transform matrix [TU(n₁,n₂)] for up-sampling data of a video block has elements expressed by

$$TU ( {n}_{1} , {n}_{2} ) = \frac{2}{N} {\sum }_{k = 0}^{N} s ( k ) \cdot p ( {n}_{2} ) \cdot cos ( \frac{π {kn}_{2}}{N} ) \cdot cos ( \frac{π {kn}_{1}}{2 N} )$$

where s(0)=s(N)=p(0)=p(N)=1/2, s(k)=p(n₂)=1, 1≦k,n₂≦N−1, 0≦n₁≦2N.

In one embodiment, the transform matrix [TD(n₁,n₂)] for down-sampling data of a video block has elements expressed by

$$TD ( {n}_{1} , {n}_{2} ) = \frac{1}{N} {\sum }_{k = 0}^{\frac{N}{2}} s ( k ) \cdot p ( {n}_{2} ) \cdot cos ( \frac{π {kn}_{2}}{N} ) \cdot cos ( \frac{2 \cdot π {kn}_{1}}{N} )$$

where s(0)=s(N/2)=p(0)=1/2, s(k)=p(n₂)=1, 1≦k,n₁≦N/2−1, 0≦n₂≦N.

In another embodiment of the present invention, the type-2 discrete cosine transform is used for the DCT.

In another embodiment, the transform matrix [TU(n₁,n₂)] for up-sampling data of a video block has elements expressed by

$$TU ( {n}_{1} , {n}_{2} ) = {\sum }_{k = 0}^{N - 1} p ( k ) \cdot cos ( \frac{π k ( 2 {n}_{2} + 1 )}{2 N} ) \cdot cos ( \frac{π k ( 2 {n}_{1} + 1 )}{4 N} )$$

where p(0)=1/N, p(k)=2/N, 1≦k≦N−1, 0≦n₂≦N−1, 0≦n₁≦2N−1.

In another embodiment, the transform matrix [TD(n₁,n₂)] for down-sampling data of a video block has elements expressed by

$$TD ( {n}_{1} , {n}_{2} ) = {\sum }_{k = 0}^{\frac{N}{2} - 1} p ( k ) \cdot cos ( \frac{π k ( 2 {n}_{2} + 1 )}{2 N} ) \cdot cos ( \frac{π k ( 2 {n}_{1} + 1 )}{ N} )$$

where p(0)=1/N, p(k)=2/N, 1≦k≦N/2−1, 0≦n₁≦N/2−1, 0≦n₂≦N−1

In one embodiment, the method for up-sampling a video block is employed by a video signal decoding apparatus.

In one embodiment, the method for down-sampling a video block is employed by a video signal encoding apparatus.

In one embodiment, another step for averaging pixel data adjacent to the boundary of each row-or each column in the up-sampled 2N×2N video block (or reduced N×N video block) is executed. The averaging step replaces the adjacent pixel data with boundary pixel data of a video block up-sampled (or down-sampled) from an adjacent video block.

### BRIEF DESCRIPTION OF THE DRAWINGS

FIGS. 1a and 1b illustrate examples of transforming time-domain pixel data into frequency-domain data;

FIGS. 2a and 2b illustrate the block diagrams of an apparatus for up-sampling video blocks using the type-1 DCT in accordance with one embodiment of the present invention;

FIG. 3 illustrates the up-sampling process executed on a row or column data of a video block to be up-sampled, conducted by the apparatus of FIG. 2a;

FIG. 4 illustrates an example of a transform matrix for enlarging an 8×8 video block into a 16×16 video block, the 11×11 video block being obtained by appending 3 pixels to each row and each column of a given 8×8 video block;

FIG. 5 illustrates the block diagrams of an apparatus for up-sampling video blocks using the type-1 DCT in accordance with another embodiment of the present invention;

FIG. 6 illustrates an example of appending adjacent pixel data to an 8×8 video block conducted prior to the up-sampling operation;

FIG. 7 illustrates the process for averaging the data of boundary pixels of each up-sampled row or column, conducted by the apparatus shown in FIG. 5;

FIGS. 8a and 8b illustrate the block diagrams of an apparatus for down-sampling video blocks using the type-1 DCT in accordance with another embodiment of the present invention;

FIG. 9 illustrates the down-sampling process executed on a row or column data of a video block to be down-sampled, conducted by the apparatus of FIG. 8a;

FIG. 10 illustrates the block diagrams of an apparatus for down-sampling video blocks using the type-1 DCT in accordance with another embodiment of the present invention;

FIG. 11 illustrates an example of appending adjacent pixel data to a 16×16 video block conducted prior to the down-sampling operation;

FIG. 12 illustrates the process for averaging the data of boundary pixels of each down-sampled row or column, conducted by the apparatus shown in FIG. 10;

FIGS. 13a and 13b illustrate the block diagrams of an apparatus for up-sampling video blocks using the type-2 DCT in accordance with yet another embodiment of the present invention;

FIG. 14 illustrates the up-sampling process executed on a row or column data of a video block to be up-sampled, conducted by the apparatus of FIG. 13a;

FIG. 15 illustrates the block diagram of an apparatus for up-sampling video blocks using the type-2 DCT in accordance with yet another embodiment of the present invention;

FIG. 16 illustrates an example of appending adjacent pixel data to an 8×8 video block conducted prior to the up-sampling operation;

FIG. 17 illustrates the process for averaging the data of boundary pixels of each up-sampled row or column, conducted by the apparatus shown in FIG. 17;

FIGS. 18a and 18b illustrate the block diagrams of an apparatus for down-sampling video blocks using the type-2 DCT in accordance with yet another embodiment of the present invention;

FIG. 19 illustrates the down-sampling process executed on a row or column data of a video block to be down-sampled, conducted by the apparatus of FIG. 18a;

FIG. 20 illustrates the block diagram of an apparatus for down-sampling video blocks using the type-2 DCT in accordance with yet another embodiment of the present invention;

FIG. 21 illustrates an example of appending adjacent pixel data to a 16×16 video block conducted prior to the down-sampling operation; and

FIG. 22 illustrates the process for averaging the data of boundary pixels of each down-sampled row or column, conducted by the apparatus shown in FIG. 20.

### BEST MODE FOR CARRYING OUT THE INVENTION

In order that the invention may be fully understood, preferred embodiments thereof will now be described with reference to the accompanying drawings.

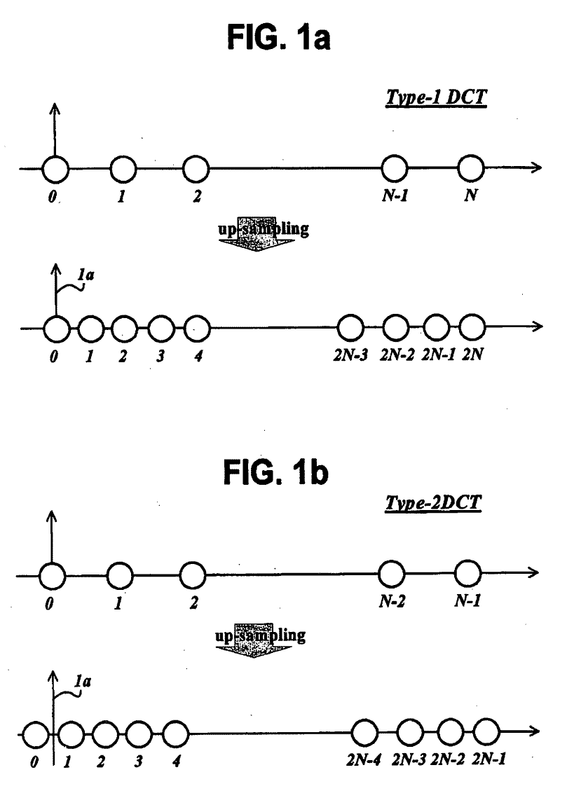

A method for up-sampling data of a video block using the type-1 discrete cosine transform (DCT) according to one embodiment of the present invention is described first. As shown in FIG. 1a, the type-1 DCT does not yield a shift in the up-sampled or down-sampled data with respect to the coordinate reference point 1a. In contrast, the type-2 DCT yields a shift in the up-sampled or down-sampled data with respect to the coordinate reference point la as shown in FIG. 1b.

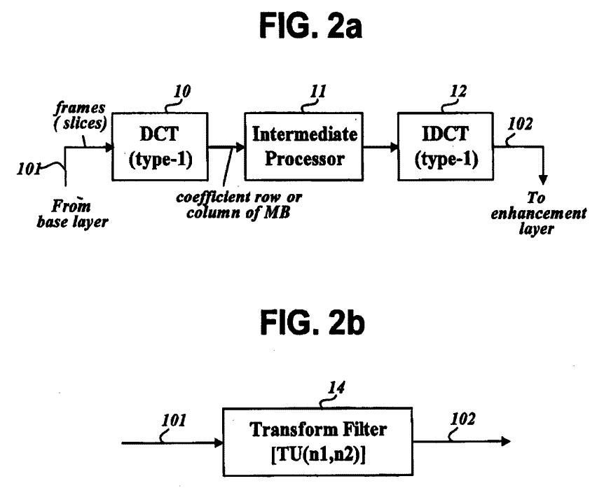

FIG. 2a shows the block diagram of an apparatus for up-sampling data of a video block using the type-1 DCT in accordance with one embodiment of the present invention. The apparatus comprises a DCT unit 10 for applying the type-1 DCT operation to each row and column of a video block contained in an input frame or slice 101 having decoded data, an intermediate processing unit 11 for assigning a weight to the coefficients obtained by the DCT operation and for padding as many zeros as needed to the coefficients, and an IDCT unit 12 for yielding up-sampled block data 102 by applying the inverse discrete cosine transform (IDCT) to the data from the intermediate processing unit 11. The input frame or slice 101 may be provided by the decoder of a lower layer.

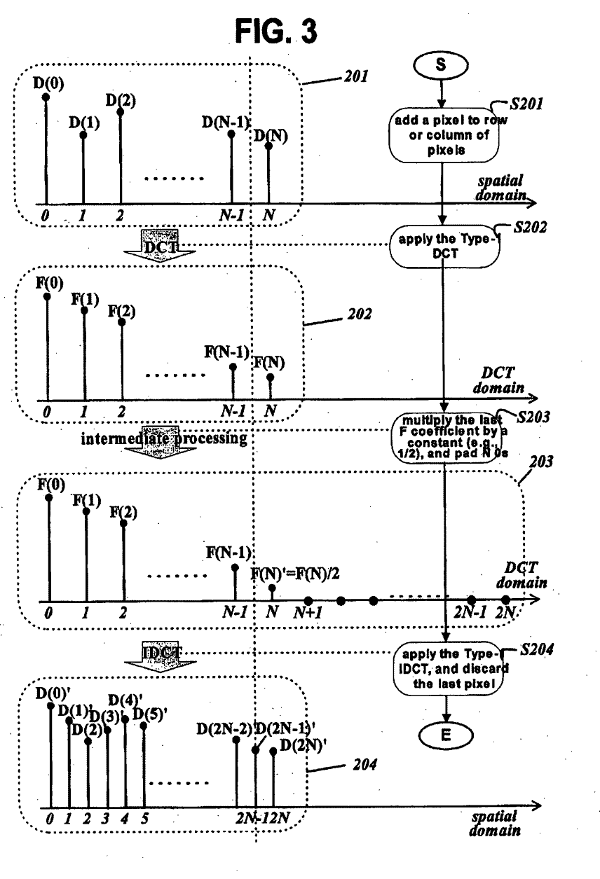

FIG. 3 illustrates an example of the up-sampling process executed on a row or column data of a video block to be up-sampled, conducted by the apparatus of FIG. 2a.

The DCT unit 10 first appends an appropriate number of pixels of a left or right adjacent video block to the N pixels D(0)˜D(N−1) in a row of the video block to be up-sampled (S201). In the example shown in FIG. 3, one adjacent pixel D(N) is appended. The DCT unit 10 then executes the DCT on the data set 201 to obtain N+1 DCT coefficients 202 expressed by

$$F ( k ) = \frac{2}{N} \cdot s ( k ) {\sum }_{n = 0}^{N} p ( n ) \cdot D ( n ) \cdot cos ( \frac{π kn}{N} ) \qquad ( equation 1 )$$

where a(0)=s(N)=p(0)=p(N)=1/2, s(k)=p(n)=1, 1≦k, n≦N.

The intermediate processing unit 11 obtains a new DCT coefficient F(N)′ by multiplying the last DCT coefficient F(N) by a weight greater than 0 and less than 1, preferably 1/2, and pads N zeros after the new DCT coefficient F(N)′ (S203). The resultant new 2N+1 coefficients 203 are thus F(0),F(1), . . . ,F(N−1),F(N)/2, F(N+1), . . . ,F(2N) with F(N+1)=F(N+2)= . . . =F(2N)=0. The reason that p(N) is set to 1/2 in equation (1) is to multiply the last coefficient F(N) by 1/2.

The IDCT unit 12 executes the IDCT on the obtained 2N+1 coefficients 203 to yield 2N+1 pixel data 204 expressed by

$${D ( n )}^{′} = {\sum }_{k = 0}^{2 N} F ( k ) \cdot cos ( \frac{π kn}{2 N} ) \qquad ( equation 2 )$$

where 0≦n≦2N. The IDCT unit 12 discards the last pixel data D(2N)′ (S204). The resultant 2N values D(0)′˜D(2N−1)′ are the pixel data of the up-sampled video block.

Applying the aforementioned procedure to each row of an N×N video block to be up-sampled results in an N×2N video block and applying the same procedure to each column of the N×2N video block results in an up-sampled 2N×2N video block. The pixel data of the up-sampled video block is provided to an encoder or decoder for processing the bit stream of an upper layer, thereby allowing the prediction between layers.

Unlike the previous embodiment which up-samples the input video block by sequential transform operations, another embodiment of the present invention obtains the row and column data of the up-sampled block simultaneously by a transform filter 14 shown in FIG. 2b. The transform filter 14 is actually a transform matrix TU[] which transforms an input matrix [D(i1, j1)] into an output matrix [D(i2, j2)′] by

[D(i2,j2)′]=[TU(n₁,n₂)][D(i1,j1)][TU(n₁,n₂)]^{T} (equation 3a)

where [D(i1,j1)] is the pixel data of the input video block and [D(i2,j2)′] is the pixel data of the up-sampled video block. The transform matrix is expressed by

$$TU ( {n}_{1} , {n}_{2} ) = \frac{2}{N} {\sum }_{k = 0}^{N} s ( k ) \cdot p ( {n}_{2} ) \cdot cos ( \frac{π {kn}_{2}}{N} ) \cdot cos ( \frac{π {kn}_{1}}{2 N} ) \qquad ( equation 3 b )$$

where s(0)=s(N)=p(0)=p(N)=1/2, s(k)=p(n₂)=1, 1≦k,n₂≦N−1, 0≦i1,j1≦N, 0≦n₁, i2,j2≦2N.

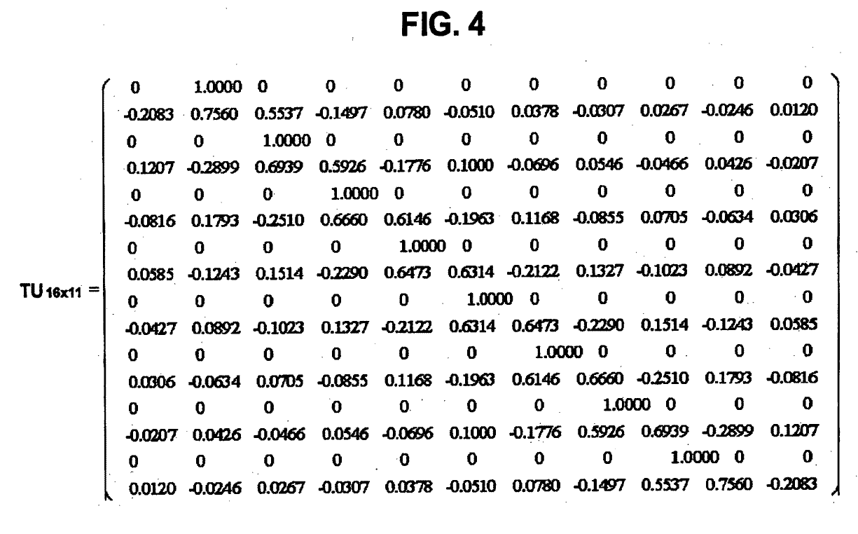

For example, the transform matrix [TU(n₁,n₂)] of the transform filter 14 for up-sampling an 11×11 video block obtained by appending 3 pixels to each of the row and column of an 8×8 video block to be up-sampled is obtained by equation (3b). The matrix obtained by equation (3b) has a dimension of 21×11 and but the up-sampled video block shall have a dimension of 16×16. Therefore, premultiplying the 21×11 matrix by a matrix for taking 16 pixel data from the 21 pixel data achieved by the 21×11 matrix yields a 16×11 transform matrix. FIG. 4 shows an example of the 16×11 transform matrix.

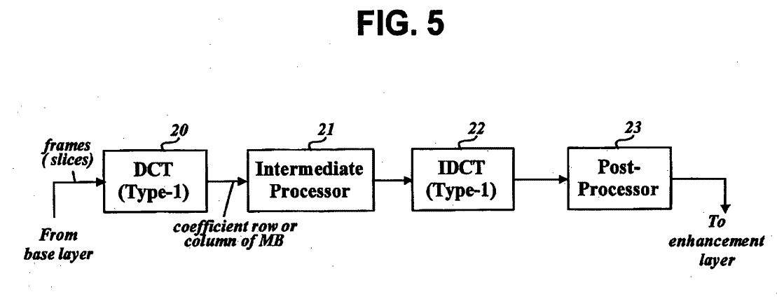

FIG. 5 shows the block diagram of an apparatus for up-sampling data of a video block using the type-1 DCT in accordance with another embodiment of the present invention.

The apparatus comprises a DCT unit 20 for applying the type-1 DCT operation to each row and column of a video block to be up-sampled contained in an input frame or slice, an intermediate processing unit 21 for assigning a weight to the coefficients obtained by the DCT operation and for padding as many zeros as needed to the coefficients, an IDCT unit 22 for applying the IDCT to the output of the intermediate processing unit 21, and a post processing unit 23 for averaging the boundary values of the pixel data obtained by the IDCT unit 22.

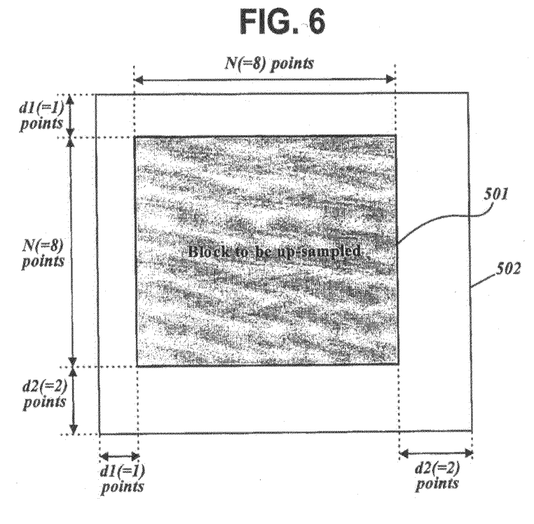

The DCT unit 20 constructs a video block of (N+d)×(N+d) pixels from an N×N input video block to be up-sampled. d is a value equal to or greater than 1. In the example shown in FIG. 6 wherein an 8×8 video block 501 is to be up-sampled and therefore N is 8, 1 (=d1) pixel is appended to the left and upper sides of each row and column respectively and 2 (=d2) pixels are appended to the right and lower sides of each row and column respectively. As a result, the 8×8 input video block 501 is first enlarged into an 11×11 block 502. When enlarging the input video block, the boundary pixels of video blocks adjacent to the input video block are simply appended if adjacent video blocks exist. In the case where there is no video block adjacent to a side of the input video block, the pixels on the corresponding boundary of the input video block are copied as many as required. Because the pixel data appended to the boundaries of each row and column is used simply for up-sampling the input video block with overlapping, the appended pixel data is used for the averaging operation to be explained below or discarded after the up-sampling of the input video block. The following description refers to the values in the example shown in FIG. 6.

The DCT unit 20 obtains 11 DCT coefficients F(0), F(1), . . . ,F(10) by executing the DCT on a row of the enlarged 11×11 video block 502 using equation (1).

The intermediate processing unit 21 obtains a new DCT coefficient F(10)′ by multiplying the last DCT coefficient F(10) by a weight greater than 0 and less than 1, preferably 1/2, and pads N+d−1 zeros (10 zeros in this example) after the new DCT coefficient F(10)′, which yields 21 DCT coefficients.

The IDCT unit 22 executes the IDCT on the obtained 21 coefficients to yield 2N+1 pixel data D_{C}(0)′,D_{C}(1)′, . . . ,D_{C}(20)′ using equation 2 and provides the obtained pixel data to the post processing unit 23.

The post processing unit 23 temporarily stores the received 21 pixel data D_{C}(0)′,D_{C}(1)′, . . . ,D_{C}(20)′ for boundary averaging of a next video block. If the 21 pixel data are obtained from a row of a video block to be up-sampled that has no adjacent left video block, the post processing unit 23 only performs the storing operation.

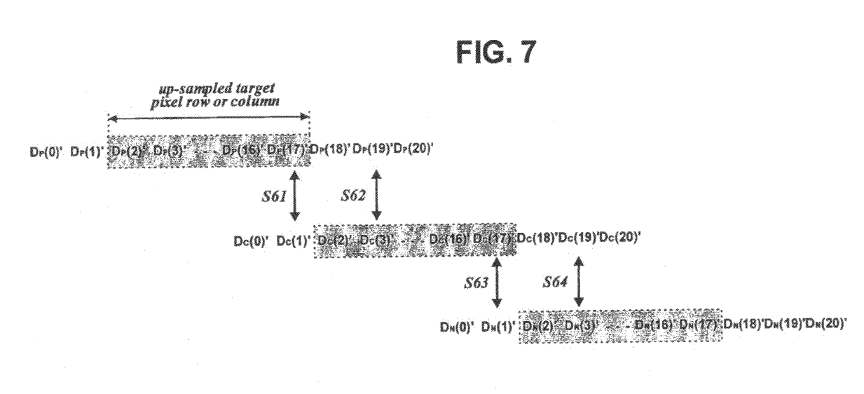

If the 21 pixel data are obtained from a row of a video block to be up-sampled that has an adjacent left video block, the post processing unit 23 calculates the average of the even-number-th pixel data among the last 2×d1 pixel data of from the (2×d1+1)-th pixel through the (2×d1+2×N)-th pixel data obtained for the corresponding row of the adjacent left video block and stored temporarily in the aforementioned manner and the even-number-th pixel data among the first 2×d1 pixel data of the obtained 21 pixel data D_{C}(0)′,D_{C}(1)′, . . . ,D_{C}(20)′ (S61). In the example shown in FIG. 7, the post processing unit 23 calculates the average of D_{P}(17)′, which is the 2nd pixel data among D_{P}(16)′ and D_{P}(17)′, the last 2 pixel data of from the 3rd to the 18th pixel data of the corresponding row of the adjacent left video block, and D_{C}(1)′, which is the 2nd pixel data among D_{C}(0)′ and D_{C}(1)′, the first 2 pixel data of the obtained 21 pixel data, wherein D_{C}(1)′ and D_{P}(17) are data obtained for the same pixel in a frame or slice. The post processing unit 23 then replaces D_{P}(17)′ with the calculated average.

Subsequently, the post processing unit 23 calculates the average of the even-number-th pixel data D_{C}(3)′ among the first 2×d2−1 (=3) pixel data D_{C}(2)′,D_{C}(3)′,D_{C}(4)′ of from the (2×d1+1)-th (3rd) pixel through the (2×d1+2×N)-th (18th) pixel of the obtained 21 pixel data D_{C}(0)′,D_{C}(1)′, . . . ,D_{C}(20) and the even-number-th pixel data D_{P}(19)′ among the last 2×d2−1 (=3) pixel data D_{P}(18)′,D_{P}(19)′,D_{P}(20)′ of the pixel data D_{P}(0)′,D_{P}(1)′, . . . ,D_{P}(20)′ (S62) and replaces D_{C}(3)′ with the calculated average. D_{C}(3)′ and D_{P}(19)′ are data obtained for the same pixel in a frame or slice.

After executing the above operation on the video block next to the video block being up-sampled, the post processing unit 23 conducts the averaging of pixel data located on the boundary between the two video blocks. Supposing the obtained 21 pixel data of a row of the next video block are D_{N}(0)′,D_{N}(1)′, . . . ,D_{N}(20)′, the post processing unit 23 replaces D_{C}(17)′ with {D_{C}(17)′+D_{N}(1)′}/2 (S63) and replaces D_{N}(3) with {D_{C}(19)′+D_{N}(3)′}/2 (S64). D_{N}(17)′ will be replaced with a value when the up-sampled pixel data for a video block next to the next video block is received.

Instead of the simple averaging of the values of pixels on block boundaries, it is possible to apply weighted averaging if necessary. For example, two pixel values may be multiplied by two different weight values a1 and a2 respectively and the pixel values on the boundaries of (e.g., the 4th and 18th pixel data in FIG. 7) are replaced with the weighted average value, where a1+a2=1 and a1>a2. In this case, pixel data of from the (2×d1+1)-th (=3rd) through (2×d1+2×N)-th (=18th) pixel is multiplied by a1 and pixel data that does not belong to the group is multiplied by a2.

Executing the above operation on each row of the video block to be up-sampled yields an (N+d)×[2(N+d)−1] (11×21 in this example) video block and executing the above operation on each column of the 11×21 video block yields a 21×21 video block. When executing the above operation on each column, an adjacent block refers to adjacent upper or lower video block. A 16×16 video block, which is constructed using the pixel values of from the (2×d1+1)-th (=3rd) through the (2×d1+2×N)-th (=18th) pixel data in each row and column, is provided to an encoder or decoder for processing the bit stream of an upper layer, thereby allowing the prediction between layers.

In the previous embodiments, the up-sampling of each column of a video block to be up-sampled is preceded by the up-sampling of each row of the video block. However,. the order. may be reversed.

A method for down-sampling data of a video block using the type-1 DCT according to one embodiment of the present invention is described.

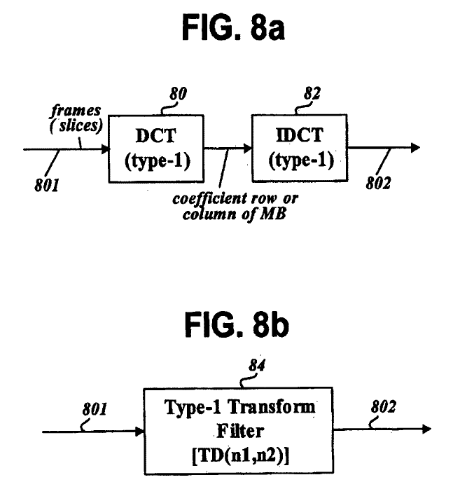

FIG. 8a shows the block diagram of an apparatus for down-sampling data of a video block using the type-1 DCT in accordance with one embodiment of the present invention. The apparatus comprises a DCT unit 10 for applying the type-1 DCT operation to each row and column of a video block contained in an input frame or slice 801 having decoded data and an IDCT unit 82 for yielding down-sampled block data 802 by applying the IDCT to low-frequency components among the DCT coefficients.

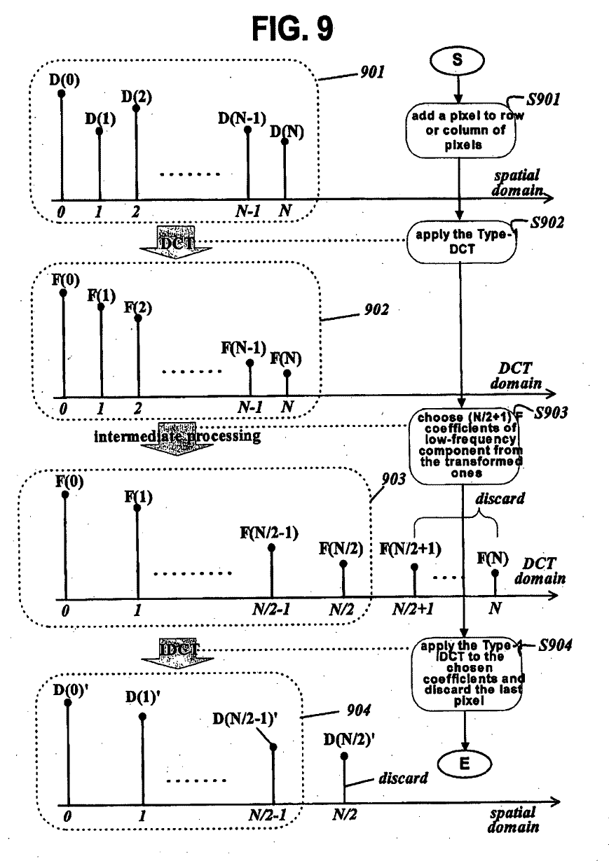

FIG. 9 shows the down-sampling process executed on a row or column data of a video block to be down-sampled, conducted by the apparatus of FIG. 8a. It is common that down-sampling operations are performed by a video signal encoder. The down-sampling method of the present invention, however, has no limitation in its application, i.e., it can be employed by either an encoder or a decoder.

The DCT unit 80 first appends an appropriate number of pixels of a left or right adjacent video block to the N pixels D(0)˜D(N−1) in a row of the video block to be down-sampled (S901). In the example shown in FIG. 9, one adjacent pixel D(N) is appended. The DCT unit 80 then executes the DCT on the data set 901 to obtain N+1 IDCT coefficients 902 (S902).

The IDCT unit 82 discards N/2 DCT coefficients F(N/2+1), . . . ,F(N−1),F(N) which correspond to high-frequency components and executes the IDCT on the remaining N/2+1 DCT coefficients F(0),F(1), . . . ,F(N/2) 903 which correspond to low-frequency components to yield N/2+1 pixel data (S90). The IDCT unit 82 discards the last pixel data D(N/2)′ (S904). The resultant N/2 values D(0)′˜D(N/2−1)′ 904 are the pixel data of the down-sampled video block.

Applying the aforementioned procedure to each row of an N×N video block to be down-sampled results in an N×(N/2) video block and applying the same procedure to each column of the N×(N/2) video block results in a down-sampled (N/2)×(N/2) video block.

Unlike the previous embodiment which down-samples the input video block by sequential transform operations, another embodiment of the present invention obtains the row and column data of the down-sampled block simultaneously by a transform filter 84 shown in FIG. 8b. The transform filter 84 is actually a transform matrix TD[] which transforms an input matrix [D(i1, j1)] into an output matrix [D(i2, j2)′] by

[D(i2,j2)′]=[TD(n₁,n₂)][D(i1,j1)][TD(n₁,n₂)]^{T} (equation 4a)

where [D(i1,j1)] is the pixel data of the input video block and [D(i2,j2)′] is the pixel data of the down-sampled video block. The transform matrix is expressed by

$$TD ( {n}_{1} , {n}_{2} ) = \frac{1}{N} {\sum }_{k = 0}^{\frac{N}{2}} s ( k ) \cdot p ( {n}_{2} ) \cdot cos ( \frac{π {kn}_{2}}{N} ) \cdot cos ( \frac{2 \cdot π {kn}_{1}}{N} ) \qquad ( equation 4 b )$$

where s(0)=s(N/2)=p(0)=1/2, s(k)=p(n₂)=1, 1≦k,n₁≦N/2−1, 0≦i2,j2≦N/2, 0≦n₂,i1,j1≦N.

For example, the transform matrix [TD_{8×21}] for down-sampling a 21×21 video block obtained by appending 5 pixels to each of the row and column of a 16×16 video block to be down-sampled is obtained by multiplying the 10×21 matrix expressed by equation (4b) by a matrix for taking 8 pixel data from 10 pixel data.

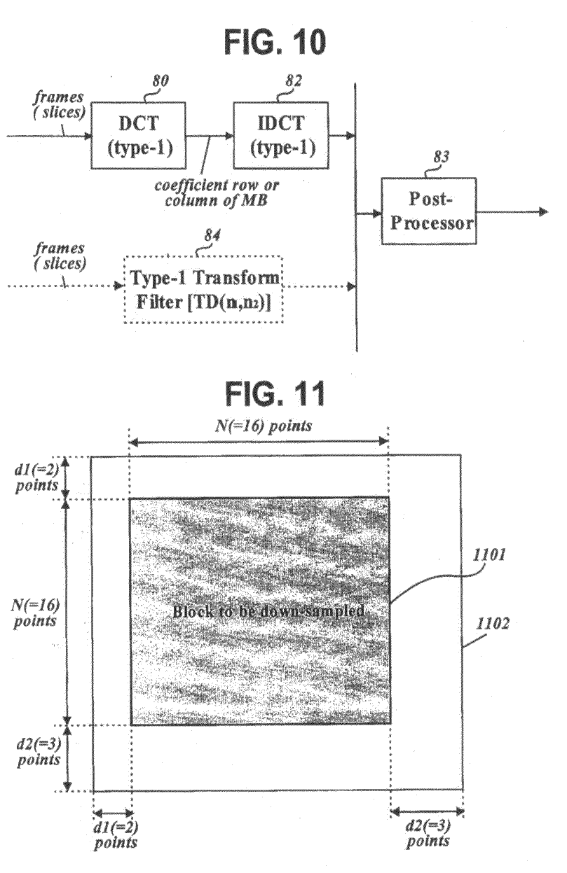

FIG. 10 shows the block diagram of an apparatus for down-sampling data of a video block using the type-1 DCT in accordance with another embodiment of the present invention.

The apparatus shown in FIG. 10 comprises the apparatus of FIG. 8a and a post processing unit 83 for averaging the boundary values of the down-sampled pixel data. The apparatus of FIG. 10 may comprise the apparatus of FIG. 8b and the post processing unit 83.

The apparatus shown in FIG. 10 constructs a video block of (N+d)×(N+d) pixels from an N×N input video block to be down-sampled. d is a value equal to or greater than 1. In the example shown in FIG. 11 wherein a 16×16 video block 1101 is to be down-sampled and therefore N is 16, 2 (=d1) pixels are appended to the left and upper sides of each row and column respectively and 3 (a d2) pixels are appended to the right and lower sides of each row and column respectively. As a result, the 16×16 input video block 1101 is first enlarged into a 21×21 block 1102 and then the enlarged video block is down-sampled. The values used in FIG. 11 are illustrative rather than restrictive and thus other values may be used freely.

When enlarging the input video block, the boundary pixels of video blocks adjacent to the input video block are simply appended if adjacent video blocks exist. In the case where there is no video block adjacent to a side of the input video block, the pixels on the corresponding boundary of the input video block are copied as many as required. Because the pixel data appended to the boundaries of each row and column is used simply for down-sampling the-input video block with overlapping, the appended pixel data is used for the averaging operation to be explained below or discarded after the down-sampling of the input video.

The down-sampling process is the same as the aforementioned one. In this case, however, the last of the obtained pixel data of a row or a. column, i.e., D(10)′, is not discarded. The post processing unit 83 of the apparatus of FIG. instead utilizes the boundary pixel data D(0)′,D(9)′,D(10)′ for averaging the target data D(1)′,D(2)′, . . . ,D(8)′, which are the 8 pixel values of a row or a column of the down-sampled video block.

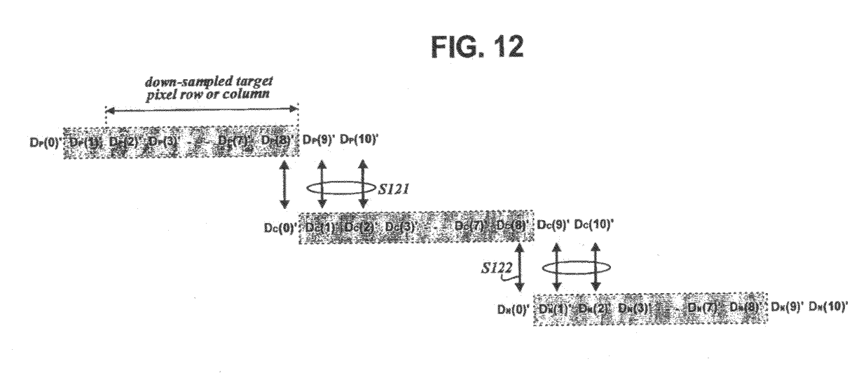

FIG. 12 shows an illustrative example of the averaging operation. The post processing unit 83 regards pixel data of from the (d1/2+1)-th (=2nd) through the (d1/2+N/2)-th (=9th) pixels as the target data and replaces the-leading two pixel values D_{C}(1)′ and D_{C}(2)′ thereof with the averages (D_{C}(1)′+D_{P}(9)′)/2 and (D_{C}(2)′+D_{P}(10)′)/2, respectively (S121). D_{P}(9)′ and D_{P}(10)′ are the last two pix el values of the corresponding row (column) of the adjacent left (upper) down-sampled video block. And the post processing unit 83 replaces the last target data, i.e., D_{C}(8), with the average (D_{C}(8)′+N(0)′)/2 after the down-sampling of the next video block is completed (S122), wherein N(0)′ is the first pixel data of the corresponding row (column) of the adjacent right (lower) down-sampled video block. Applying the above operation to each row and column of the video block to be down-sampled and taking pixel data that belongs to the target data results in down-sampling of video data with no conspicuous block boundaries.

A method for up-sampling data of a video block using the type-2 DCT according to another embodiment of the present invention is described from now on.

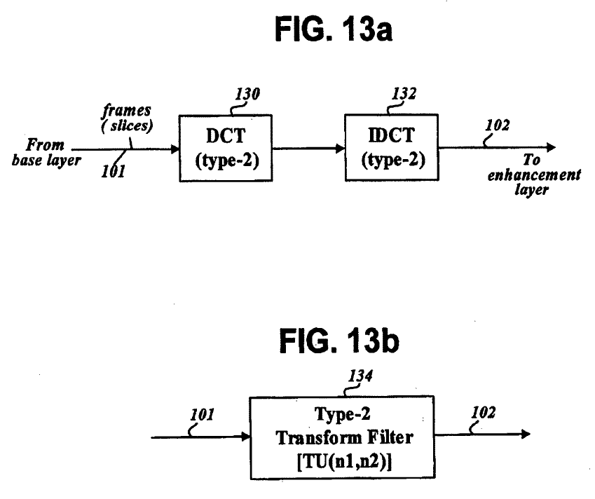

FIG. 13a shows the block diagram of an apparatus for up-sampling data of a video block using the type-2 DCT in accordance with one embodiment of the present invention. The apparatus comprises a DCT unit 130 for applying the type-2 DCT operation to each row and column of a video block contained in an input frame or slice 101 having decoded data and an IDCT unit 132 for yielding up-sampled block data 102 by padding as many zeros as needed to the obtained coefficients and applying the IDCT to the zero-padded coefficients. The input frame or slice 101 may be provided by the decoder of a lower layer.

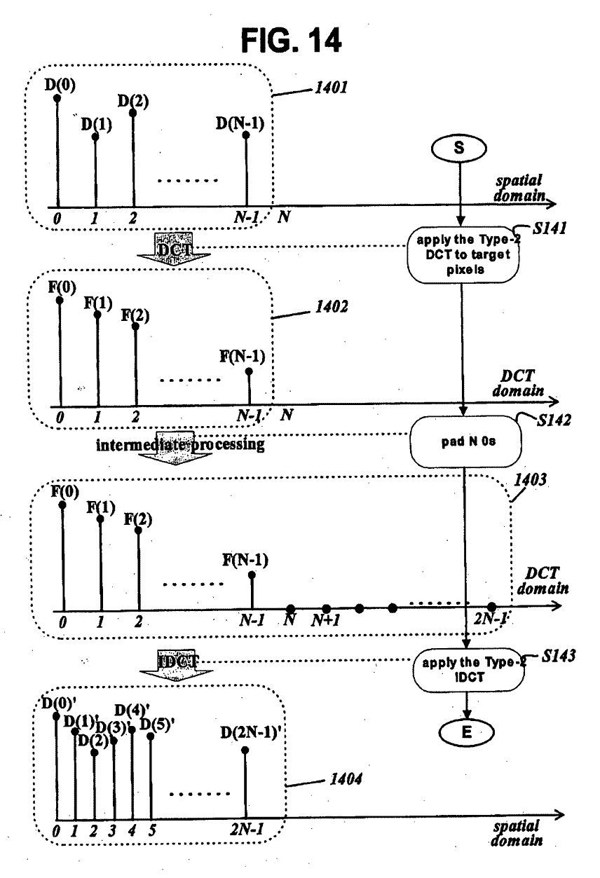

FIG. 14 illustrates an example of the up-sampling process executed on a row or column data of a video block to be up-sampled, conducted by the apparatus of FIG. 13a.

The DCT unit 130 executes the type-2 DCT on pixel data D(0)˜D(N−1) 1401 of a row of a video block to be up-sampled (S141) to obtain N DCT coefficients 1402 expressed by

$$\begin{matrix} F ( k ) = s ( k ) {\sum }_{n = 0}^{N - 1} x ( n ) \cdot cos ( \frac{π k ( 2 n + 1 )}{2 N} ) \\ where s ( 0 ) = \frac{1}{\sqrt{N}} , s ( k ) = \frac{\sqrt{2}}{\sqrt{N}} , 1 = \leq k \leq N - 1.\end{matrix} \qquad ( equation 5 )$$

The IDCT unit 132 obtains 2N new DCT coefficients 1403 by appending N zeros after the obtained N DCT coefficients (S142). The resultant new 2N coefficients 1403 are thus F(0),F(1), . . . ,F(N−1),F(N),F(N+1), . . . ,F(2N−1) with F(N)=F(N+2)= . . . =F(2N−1)=0.

The IDCT unit 132 then executes the IDCT on the obtained 2N coefficients 1403 to yield 2N pixel data 1404 (S143). The resultant 2N values D(0)′˜D(2N−1)′ are the pixel data of the up-sampled video block.

Applying the aforementioned procedure to each row of an N×N video block to be up-sampled results in an N×2N video block and applying the same procedure to each column of the N×2N video block results in an up-sampled 2N×2N video block. The pixel data of the up-sampled video block is provided to an encoder or decoder for processing the bit stream of an upper layer, thereby allowing the prediction between layers.

Unlike the previous embodiment which up-samples the input video block by sequential transform operations, another embodiment of the present invention obtains the row and column data of the up-sampled block simultaneously by a transform filter 134 shown in FIG. 13b. The transform filter 134 is actually a transform matrix TUC[] which transforms an input matrix [D(i1, j1)] into an output matrix [D(i2, j2)′] by

[D(i2,j2)′]=[TU(n₁,n₂)][D(i1,j1)][TU(n₁,n₂)]^{T} (equation 6a)

where [D(i1,j1)] is the pixel data of the input video block and [D(i2,j2)′] is the pixel data of the up-sampled video block. The transform matrix is expressed by

$$TU ( {n}_{1} , {n}_{2} ) = {\sum }_{k = 0}^{N - 1} p ( k ) \cdot cos ( \frac{π k ( 2 {n}_{2} + 1 )}{2 N} ) \cdot cos ( \frac{π k ( 2 {n}_{1} + 1 )}{4 N} ) \qquad ( equation 6 b )$$

where p(0)=1/N, p(k)=2/N, 1≦k≦N−1, 0≦n₂,i1,j1≦N−1, 0≦n₁,i2,j2≦2N−1.

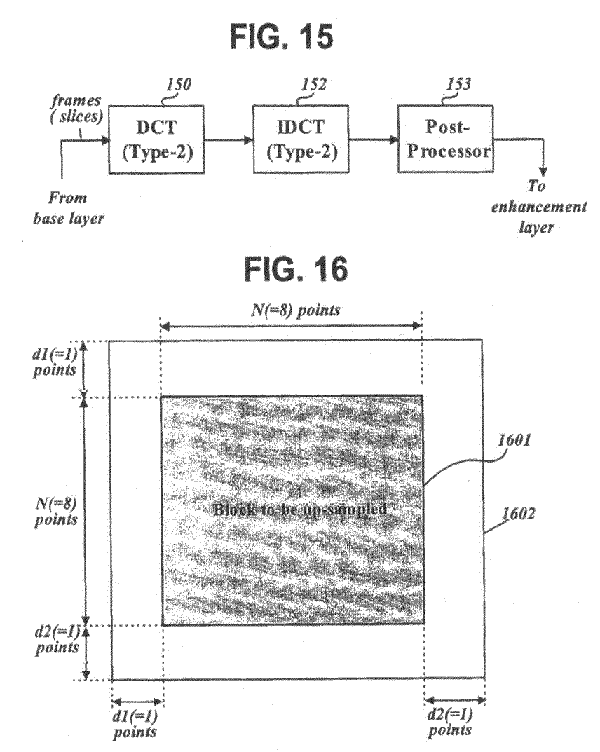

FIG. 15 shows the block diagram of an apparatus for up-sampling data of a video block using the type-2 DCT in accordance with another embodiment of the present invention.

The apparatus comprises a DCT unit 150 for applying the type-2 DCT operation to each row and column of a video block to be up-sampled contained in an input frame or slice, an IDCT unit 152 for padding as many zeros as needed to the obtained coefficients and for applying the type-2 IDCT to the zero-padded coefficients, and a post processing unit 153 for averaging the boundary values of the pixel data obtained by the IDCT unit 152.

The DCT unit 150 constructs a video block of (N+d)×(N+d) pixels from an N×N input video block to be up-sampled. d is a value equal to or greater than 1. In the example shown in FIG. 16 wherein an 8×8 video block 1601 is to be up-sampled and therefore N is 8, 1 (=d1) pixel is appended to the left and upper sides of each row and column respectively and 1 (=d2) pixel is appended to the right and lower sides of each row and column respectively. As a result, the 8×8 input video block 1601 is first enlarged into an 10×10 block 1602. When enlarging the input video block, the boundary pixels of video blocks adjacent to the input video block are simply appended if adjacent video blocks exist. in the case where there is no video block adjacent to a side of the input video block, the pixels on the corresponding boundary of the input video block are copied as many as required.

The up-sampling process which was described with reference to FIG. 14 is executed on each row and column of the constructed video block 1602. The up-sampling operation may be performed simultaneously by the apparatus shown in FIG. 13b.

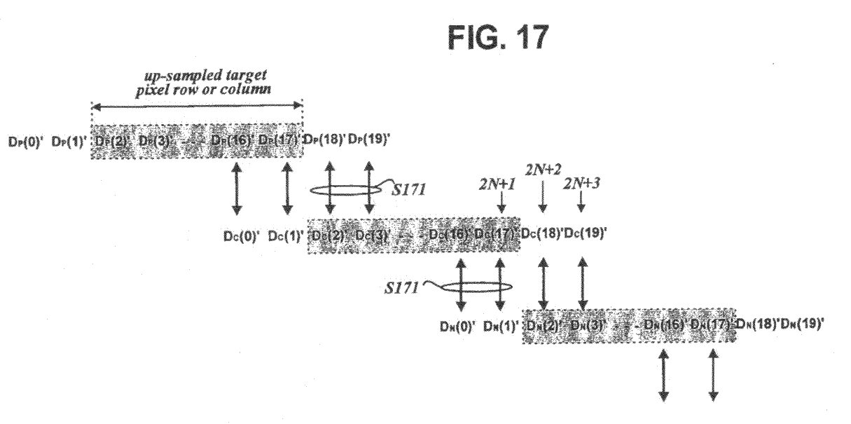

Each row or column of the enlarged video block in the example shown in FIG. 16 has 20 pixels. The post processing unit 153 in FIG. 15 regards pixel data of from the (2×d1+1)-th (=3rd) through the 2N-th (=16th) pixels as the target data and performs averaging operations (S171) which replace the leading 2×d1 (=2) pixel values (D(2) and D(3)′ in FIG. 17) and the last 2×d1 (=2) pixel values (D(16)′ and D(17)′ in FIG. 17) with averages between the pixel values and adjacent pixels that does not belong to the target data of the enlarged block.

Instead of the simple averaging of the values of pixels on block boundaries, it is possible to apply weighted averaging if necessary.

Applying the aforementioned procedure to each row and column of the given video block results in an up-sampled 16×16 video block. The pixel data of the up-sampled video block is provided to an encoder or decoder for processing the bit stream of an upper layer, thereby allowing the prediction between layers.

A method for down-sampling data of a video block using the type-2 DCT according to another embodiment of the present invention is described.

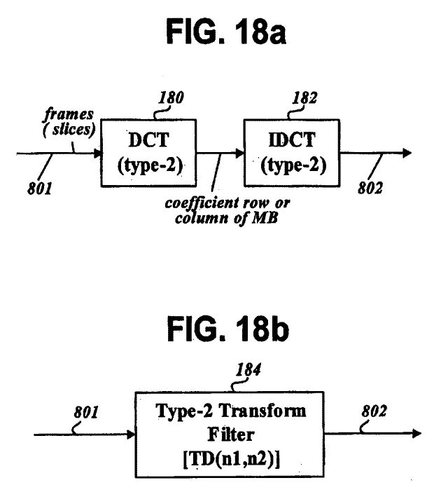

FIG. 18a shows the block diagram of an apparatus for down-sampling data of a video block using the type-2 DCT in accordance with one embodiment of the present invention. The apparatus comprises a DCT unit 180 for applying the type-2 DCT operation to each row and column of a video block contained in an input frame or slice 801 having decoded data and an IDCT unit 182 for yielding down-sampled block data 802 by applying the IDCT to low-frequency components among the DCT coefficients.

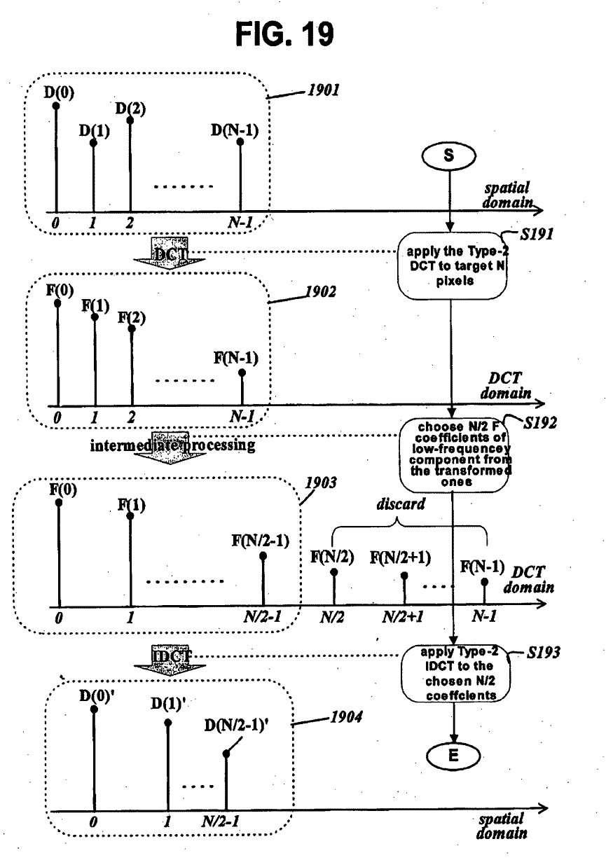

FIG. 19 shows the down-sampling process executed on a row or column data of a video block to be down-sampled, conducted by the apparatus of FIG. 18a.

The DCT unit 180 first executes the type-2 DCT on N pixel data D(0)˜D(N−1) 1901 of a row of a video block to be down-sampled to obtain N DCT coefficients 1902 (S191).

The IDCT unit 182 discards N/2 DCT coefficients F(N/2), . . . ,F(N−2),F(N−1) which correspond to high-frequency components (S192) and executes the type-2 IDCT on the remaining N12 DCT coefficients F(0),F(1), . . . ,F(N/2−1) 1903 which correspond to low-frequency components to yield N/2 pixel data (S193). The resultant N/2 values D(0)′˜D(N/2−1)′ 1904 are the pixel data of the down-sampled video block.

Applying the-aforementioned procedure to each row of an N×N video block to be down-sampled results in an N×(N/2) video block and applying the same procedure to each column of the N×(N/2) video block results in a down-sampled (N/2)×(N/2) video block.

Unlike the previous embodiment which down-samples the input video block by sequential transform operations, another embodiment of the present invention obtains the row and column data of the down-sampled block simultaneously by a transform filter 184 shown in FIG. 18b. The transform filter 184 is actually a transform matrix TD[] which transforms an input matrix [D(i1, j1)] into an output matrix [D(i2, j2)′] by

[D(i2,j2)′]−[TD(n₁,n₂)][D(i1,j1)][TD(n₁,n₂)]^{T} (equation 7a)

where [D(i1,j1)] is the pixel data of the input video block and [D(i2,j2)′] is the pixel data of the down-sampled video block. The transform matrix is expressed by

$$TD ( {n}_{1} , {n}_{2} ) = {\sum }_{k = 0}^{\frac{N}{2} - 1} p ( k ) \cdot cos ( \frac{π k ( 2 {n}_{2} + 1 )}{2 N} ) \cdot cos ( \frac{π k ( 2 {n}_{1} + 1 )}{N} ) \qquad ( equation 7 b )$$

where p(0)=1/N, p(k)=2/N 1≦k≦N/2−1, 0≦n₁, i2, j2≦N/2−1, 0≦n₂,i1,j1≦N−1.

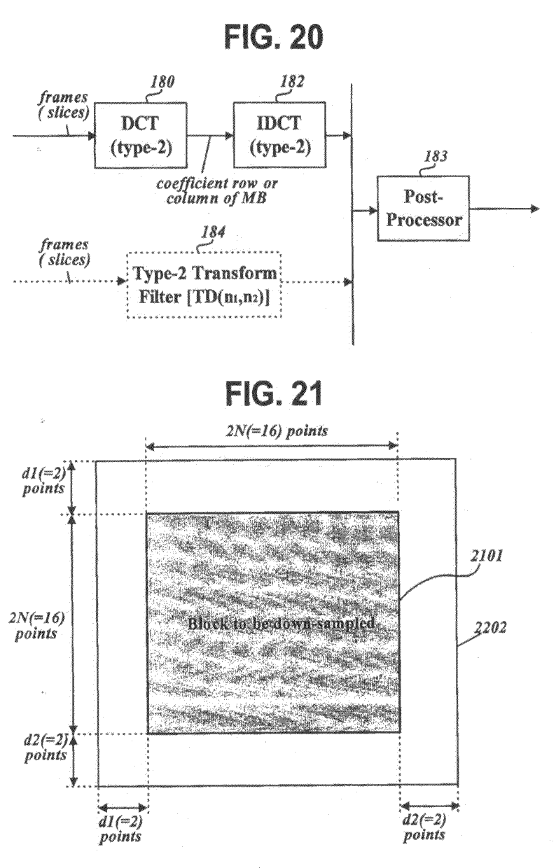

FIG. 20 shows the block diagram of an apparatus for down-sampling data of a video block using the type-2 DCT in accordance with another embodiment of the present invention.

The apparatus shown in FIG. 20 comprises the apparatus of FIG. 18a and a post processing unit 183 for averaging the boundary values of the down-sampled pixel data. The apparatus of FIG. 20 may comprise the apparatus of FIG. 18b and the post processing unit 183.

The apparatus shown in FIG. 20 constructs a video block of (2N+d)×(2N+d) pixels from a 2N×2N input video block to be down-sampled. d is a value equal to or greater than 1. In the example shown in FIG. 21 wherein a 16×16 video block 2101 is to be down-sampled and therefore N is 8, 2 (=d1) pixels are appended to the left and upper sides of each row and column respectively and 2 (=d2) pixels are appended to the right and lower sides of each row and column respectively. As a result, the 16×16 input video block 2101 is first enlarged into a 20×20 block 2102 and then the enlarged video block is down-sampled. The values used in FIG. 21 are illustrative rather than restrictive and thus other values may be used freely.

The down-sampling process is the same as the aforementioned one. In this case, however, the post processing unit 183 of the apparatus of FIG. 20 performs the averaging of the pixel data located on the boundaries of the target data of the obtained pixels D(0)′,D(1)′, . . . ,D(9)′. The target data is the N pixel data starting from the (d1/2+1)-th pixel.

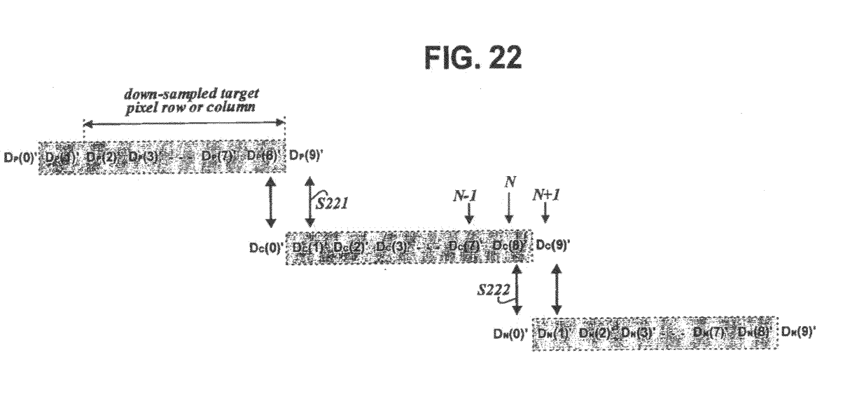

FIG. 22 shows an illustrative example of the averaging operation. The post processing unit 183 replaces the first pixel of the target data D_{C}(0)′,D_{C}(1)′, . . . , D_{C}(9)′, i.e., D_{C}(1)′, with (D_{C}(1)′+D_{P}(8)′)/2 (S221) and replaces the last pixel of the target data, i.e., D_{C}(8)′, with (D_{C}(8)′+D_{N}(0)′)/2 (S222). D_{P}(8)′ is an adjacent pixel data of the corresponding row (column) of the adjacent left (upper) down-sampled video block and D_{N}(0)′ is an adjacent pixel data of the corresponding row (column) of the adjacent right (lower) down-sampled video block. Applying the above operation to each row and column of the video block to be down-sampled and taking pixel data that belongs to the target data results in down-sampling of video data with no conspicuous block boundaries.

The aforementioned apparatus for up-sampling or down-sampling of data of a video block may be implemented in a mobile terminal, in a decoder of a recording medium reproducing apparatus, or in a digital video signal encoding apparatus.

The aforementioned method for up-sampling or down-sampling of data of a video block may be utilized for simple up-sampling or down-sampling of an input video instead of prediction between layers.

At least one embodiment of the present invention does not yield a pixel shift in the up-sampling or down-sampling of a video block and thereby reduces artifact effects in the up-sampled block with no additional operations on the up-sampled data.

While the invention has been disclosed with respect to a limited number of embodiments, those skilled in the art, having the benefit of this disclosure, will appreciate numerous modifications and variations therefrom. It is intended that all such modifications and variations fall within the spirit and scope of the invention.

1. A method for up-sampling a video block of size N×N pixels, comprising the step of:
(a) obtaining an up-sampled video block of size 2N×2N pixels by operating a transform matrix on data of the video block,
the transform matrix having elements for leading to resultant data that could be obtained by applying the discrete cosine transform (DCT) to the data of the video block, padding zeros to coefficients obtained by the DCT, and applying the inverse discrete cosine transform (IDCT) to the zero-padded coefficients.

2. The method of claim 1, wherein the step (a) premultiplies the video block by the transform matrix and postmultiplies the video block by the transpose of the transform matrix.

3. The method of claim 1, wherein the DCT is the type-1 discrete cosine transform.

4. The method of claim 3, wherein the step (a) obtains the up-sampled video block of size 2N×2N pixels by constructing a video block of (N+d)×(N+d) pixels by appending video data to the video block, obtaining an up-sampled video block of size (2N+d)×(2N+d) pixels by operating the transform matrix on the constructed video block, and then removing d pixels from each row and column of the up-sampled video block of size (2N+d)×(2N+d) pixels.

5. The method of claim 4, wherein d is 1.

6. The method of claim 3, wherein each element of the transform matrix TU(n₁,n₂) is expressed by
$$TU ( {n}_{1} , {n}_{2} ) = \frac{2}{N} {\sum }_{k = 0}^{N} s ( k ) \cdot p ( {n}_{2} ) \cdot cos ( \frac{π {kn}_{2}}{N} ) \cdot cos ( \frac{π {kn}_{1}}{2 N} )$$
with s(0)=s(N)=p(0)=p(N)=1/2, s(k)=p(n₂)=1, 1≦k,n₂≦N−1, 0≦n₁≦2N.

7. The method of claim 1, wherein the DCT is the type-2 discrete cosine transform.

8. The method of claim 7, wherein each element of the transform matrix TU(n₁,n₂) is expressed by
$$TU ( {n}_{1} , {n}_{2} ) = {\sum }_{k = 0}^{N - 1} p ( k ) \cdot cos ( \frac{π k ( 2 {n}_{2} + 1 )}{2 N} ) \cdot cos ( \frac{π k ( 2 {n}_{1} + 1 )}{4 N} )$$
with p(0)=1/N, p(k)=2/N, 1≦k≦N−1, 0≦n₂≦N−1, 0≦n₁≦2N−1.

9. The method of claim 1, further comprising the step of:
(b) averaging pixel data adjacent to the boundary of each row or each column in the up-sampled video block of size 2N×2N pixels by using boundary pixel data of video blocks up-sampled from adjacent video blocks.

10. The method of claim 1, wherein the step (a) is executed in the process of decoding a video signal.

11. The method of claim 1, wherein the padded zeros correspond to DCT coefficients having high-frequency components.

12. A method for down-sampling a video block of size 2N×2N pixels, comprising the step of:
(a) obtaining a down-sampled video block of size N×N pixels by operating a transform matrix on data of the video block,
the transform matrix having elements for leading to resultant data that could be obtained by applying the discrete cosine transform (DCT) to the data of the video block, removing some of the coefficients obtained by the DCT, and applying the inverse discrete cosine transform (IDCT) to the set of the reduced number of coefficients.

13. The method of claim 12, wherein the step (a) premultiplies the video block by the transform matrix and postmultiplies the video block by the transpose of the transform matrix.

14. The method of claim 12, wherein the DCT is the type-l discrete cosine transform.

15. The method of claim 14, wherein the step (a) obtains the down-sampled video block of size N×N pixels by constructing a video block of (2N+d)×(2N+d) pixels by appending video data to the video block, obtaining a down-sampled video block of size (N+d)×(N+d) pixels by operating the transform matrix on the constructed video block, and then removing d pixels from each row and column of the down-sampled video block of size (N+d)×(N+d) pixels.

16. The method of claim 15, wherein d is 1.

17. The method of claim 14, wherein each element of the transform matrix TD(n₁,n₂) is expressed by
$$TD ( {n}_{1} , {n}_{2} ) = \frac{1}{N} {\sum }_{k = 0}^{\frac{N}{2}} s ( k ) \cdot p ( {n}_{2} ) \cdot cos ( \frac{π {kn}_{2}}{N} ) \cdot cos ( \frac{2 \cdot π {kn}_{1}}{N} )$$
with s(0)=s(N/2)=p(0)=1/2, s(k)=p(n2)=1, 1≦k,n2≦N/2−1, 0≦n1≦N.

18. The method of claim 12, wherein the DCT is the type-2 discrete cosine transform.

19. The method of claim 18, wherein each element of the transform matrix TD(n₁,n₂) is expressed by
$$TD ( {n}_{1} , {n}_{2} ) = {\sum }_{k = 0}^{\frac{N}{2} - 1} p ( k ) \cdot cos ( \frac{π k ( 2 {n}_{2} + 1 )}{2 N} ) \cdot cos ( \frac{π k ( 2 {n}_{1} + 1 )}{N} )$$
with p(0)=1/N, p(k)=2/N, 1≦k≦N/2−1, 0≦n2≦N/2−1, 0≦n1≦N−1.

20. The method of claim 12, further comprising the step of:
(b) averaging pixel data adjacent to the boundary of each row or each column in the down-sampled video block of size N×N pixels by using boundary pixel data of video blocks down-sampled from adjacent video blocks.

21. The method of claim 12, wherein the step (a) is executed in the process of encoding a video signal

22. The method of claim 12, wherein the removed coefficients correspond to DCT coefficients having high-frequency components.
